(19) United States
(12) Patent Application Publication
(10) Pub. No.: US 2019/0247146 A1
(43) Pub. Date: Aug. 15, 2019

(54) Working Length Confirmation Utilizing Negative Pressure Irrigating Technique And Handpiece

(71) Applicants: Saju Joseph George, Princeton, NJ (US); George Vijay Joseph, Princeton, NJ (US); Sanjay Jacob George, Princeton, NJ (US)

(72) Inventors: Saju Joseph George, Princeton, NJ (US); George Vijay Joseph, Princeton, NJ (US); Sanjay Jacob George, Princeton, NJ (US)

(21) Appl. No.: 15/894,860

(22) Filed: Feb. 12, 2018

(51) Int. Cl. A61C 5/40; A61C 17/02; A61C 1/08; A61C 1/05; A61C 1/00; A61C 5/50

(52) U.S. Cl. CPC A61C 5/40; A61C 17/0202; A61C 17/0208; A61C 5/50; A61C 1/052; A61C 1/0092; A61C 1/088

(57) ABSTRACT

The invention relates to a handpiece for simultaneously irrigating and suctioning during an endodontic procedure, the handpiece comprising a handle portion comprising a first fluid line and a second fluid line passing into a head portion comprising an outlet for the first fluid line and an inlet for the second fluid line. The invention also relates to a method of performing a dental procedure such as a root canal. The handpiece permits the procedure of irrigating, cleansing and disinfection to be conducted by a single operator such as an endodontist, a dentist or even a dental student.

### CROSS-REFERENCE TO RELATED APPLICATIONS

This application is a utility application claiming the benefit of priority of provisional patent application No. 62/457,217, filed on Feb. 10, 2017, the contents of which are incorporated herein in their entirety.

### BACKGROUND OF THE INVENTION

Positive pressure irrigation is the most commonly used irrigating technique in endodontics today. This can be attributed to many factors which include ease of use, low cost, and training techniques in dental institutions. This technique has limitations which include high pressure during use (13) inability to safely irrigate the apical third of the root canal system without causing hypochlorite (NaOCl) accidents (9). The most important limitation is the inability to utilize high volume of irrigants (8). Negative pressure irrigation is a technique that involves circulating the irrigating solution throughout the entire working length of the root canal system. The preparation of the root canal system is critical for the smooth functioning of the negative pressure irrigating apparatus. A hybrid instrumentation technique (6) utilizes TF adaptive files for the coronal preparation and light speed instrumentation system for the apical 5 mm of the root canal system. The use of light speed creates a parallel preparation with minimal apical transportation (2, 3) removing all apical anatomical interferences for the smooth movement of the negative pressure micro cannula to working length thereby preventing it from bending as well as clogging up. Negative pressure irrigation has other advantages which include removal of the apical vapor lock (7), increased flow of irrigants through the apex (8), drainage of large apical cysts (12), improved removal of the smear layer (11) and decreased bacteria counts in the apical third of the root canal system (10).

During the In Vivo use of the negative pressure irrigating system it was noticed that the flow of the irrigant slowed down as it approached the apical constricture and actually stopped as it approximated the root apex. This observation seemed to happen consistently and hence it was decided to see whether we could utilize this technique in an In Vitro setting as a way to develop a formula to confirm final working length. There are many ways of determining working lengths which include apex locators, 3D CBCT length measuring techniques, working length x rays. The limitation of 3D CBCT length measuring technique is that it cannot give us the location of the apical constricture. The use of the apex locators involves the utilization of the canal probe for final length measurements thereby risking the introduction of the contaminants as well as debris formation once the root canal system has finally rinsed. The two dimensional x ray technique is not accurate in areas of the mouth that are hard to reach and difficult to interpret when anatomical structures approximate the root apices.

Further, the inventor has identified a long felt, unmet need in the field, the ability to use combined positive pressure and negative pressure irrigation with a single handpiece operated by a single operator.

### SUMMARY OF THE INVENTION

In one general aspect, the invention relates to a handpiece for simultaneously irrigating and suctioning during an endodontic procedure, the handpiece comprising a handle portion comprising a first fluid line and a second fluid line passing into a head portion comprising an outlet for the first fluid line and an inlet for the second fluid line.

Embodiments may comprise one or more of the following features. For example, the first fluid line and the outlet for the first fluid line may form fluid tight a connection and the second fluid line and the inlet for the second fluid line form a fluid tight connection. The handpiece may further include a third line passing between the handle portion and the head portion, wherein the third line comprises a fiber optic cable and the head portion includes a light source. The handpiece may further include a fourth line passing between the handle portion and the head portion, wherein the fourth line provides high pressure air to turn the head.

The handpiece may further include an irrigation tube mountable to the inlet for the second fluid line at the head portion. The irrigation tube may have a channel passing between a first open end and a second open end. The irrigation tube may be made of stainless steel, a nickel titanium alloy, aluminum, or a polymer.

The handpiece may further include a console having a first pump, a second pump, a first chamber, and a second chamber, wherein the first pump creates a negative pressure to suction fluid into the first chamber, the second pump creates a positive pressure to pump fluid from the second chamber. The console may further include a mounting end for mounting a cable from the console to the handpiece to provide a fluid connection between the first fluid line in the handpiece and the second pump and provide a fluid connection between the second fluid line in the handpiece and the first pump, whereby operating the console with the handpiece provides fluid through the second fluid line in the handpiece and suction fluid through the first fluid line in the handpiece.

In another general aspect, the invention relates to a method for irrigating during a dental or endodontic procedure. The method includes:

providing a handpiece for simultaneously irrigating and suctioning during the dental procedure, the handpiece comprising a handle portion comprising a first fluid line and a second fluid line passing into a head portion comprising an outlet for the first fluid line and an inlet for the second fluid line;

providing a console having a first pump, a second pump, a first chamber, and a second chamber, wherein the first pump creates a negative pressure to suction fluid into the first chamber, the second pump creates a positive pressure to pump fluid from the second chamber;

forming a first fluid connection between the handpiece and the console, the first fluid connection being between the first fluid line in the handpiece and the second pump, whereby operating the console with the handpiece suctions fluid through the first fluid line in the handpiece; and forming a second fluid connection between the handpiece and the console, the second fluid connection being between the second fluid line in the handpiece and the first pump, whereby operating the console with the handpiece provides fluid through the second fluid line in the handpiece.

Embodiments of the method may include one or more of the following features. For example, the handpiece may further include an irrigation tube mounted to the inlet for the second fluid line in the head portion, the irrigation tube having a first opening, a second opening and a channel between the first opening and the second opening. The method may further include inserting the irrigation tube into a cavity while simultaneously irrigating and suctioning through the handpiece.

The cavity may be a root canal formed in an endodontic procedure. The dental procedure may be a root canal procedure.

One or more of the handpiece and the console may further include a sensor for detecting air bubbles or fluid flow and detecting air bubbles or a reduction in fluid flow causes emission of an audible or visual signal.

The method may further include advancing the irrigation tube into the cavity until air bubbles are drawn into the irrigation tube. The method may further include advancing the irrigation tube into the apical third of the root until reaching the apical vapor lock.

The method may be characterized by operation of the handpiece by a single operator.

According to the method, the handpiece may further include a third line passing between the handle portion and the head portion, wherein the third line comprises a fiber optic cable and the head portion includes a light source. According to the method, the handpiece may further include a fourth line passing between the handle portion and the head portion, wherein the fourth line provides high pressure air to turn the head.

### BRIEF DESCRIPTION OF THE DRAWINGS

FIG. 1 is an illustration of a hollow bead sealed to the root apex of a tooth with wax.

FIG. 2 is an illustration of a tooth of FIG. 1 mounted in a plaster/acrylic block.

FIG. 3 is an illustration of an Endo Vac micro cannula.

FIG. 4 is an illustration of an Endo Vac setup.

FIG. 5 is an illustration of LSX Size 25 to 60.

FIG. 6 is an illustration of a preop x-ray if a tooth.

FIG. 7 is an illustration of a working length x-ray.

FIG. 8 is an illustration of an x-ray of a Micro Cannula working length.

FIG. 9 is an illustration of a preop x-ray of a tooth of Case 1.

FIG. 10 is an illustration of a working length x-ray of the tooth of Case 1.

FIG. 11 is an illustration of an x-ray of the tooth of Case 1 with a Micro Cannula working length.

FIG. 12 is an illustration of an x-ray of the tooth of Case 11.

FIG. 13 is an illustration of an x-ray of the tooth of Case 11.

FIG. 14 is an illustration of an x-ray of the tooth of Case III with 1 mm over extension due to resorbed apex.

FIG. 15 is a front view of a handpiece for providing positive and negative irrigation.

FIG. 16 is a side view of the mounting of the irrigation tube to the head of the handpiece.

FIG. 17 is a perspective view of a console for operating the handpiece of FIG. 15.

### DETAILED DESCRIPTION OF THE INVENTION

This invention was developed as the result of observations made during the use of micro cannula in the endo vac system in an endodontic procedure. It was observed that as the micro cannula approached the working length, the flow of the irrigant slowed down and stopped. Based on this observation, a study was conducted. In the study, fifty extracted teeth were utilized to study the invention and associated technique. The teeth were accessed, and working length were determined with a hand file introduced to 0.5 mm from the apex and x rays were taken. The teeth were then instrumented with a hybrid technique utilizing hand instruments, TF adaptive files and light speed instrumentation. Teeth were then irrigated utilizing negative pressure technique. As the micro cannulas approached the apical constricture, the flow of fluid changed in the irrigating system. First the fluid flow reduced and then bubbles were released as the micro cannulas approached the root apex. The length was then recorded and compared to the initial working length measurement. It was determined that working length can accurately be reproduced using a formula of working length minus 0.5 mm.

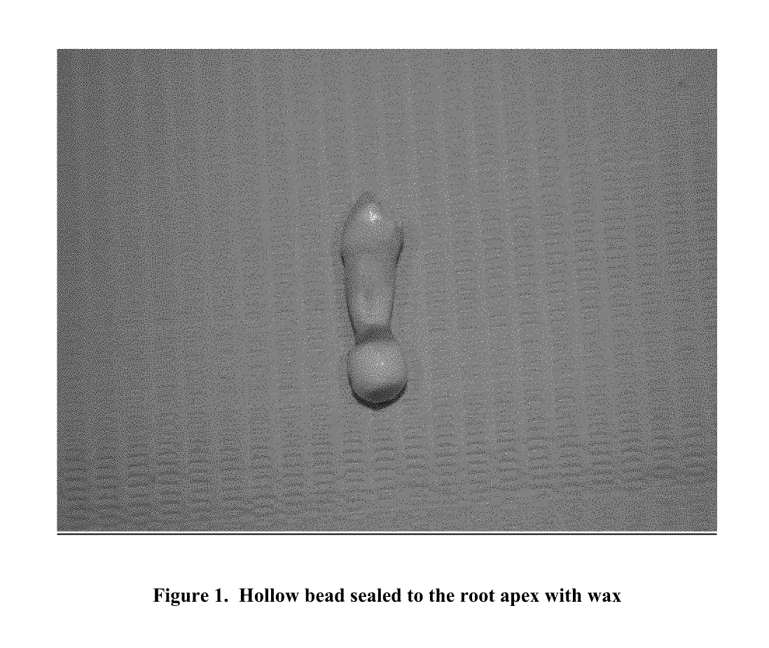

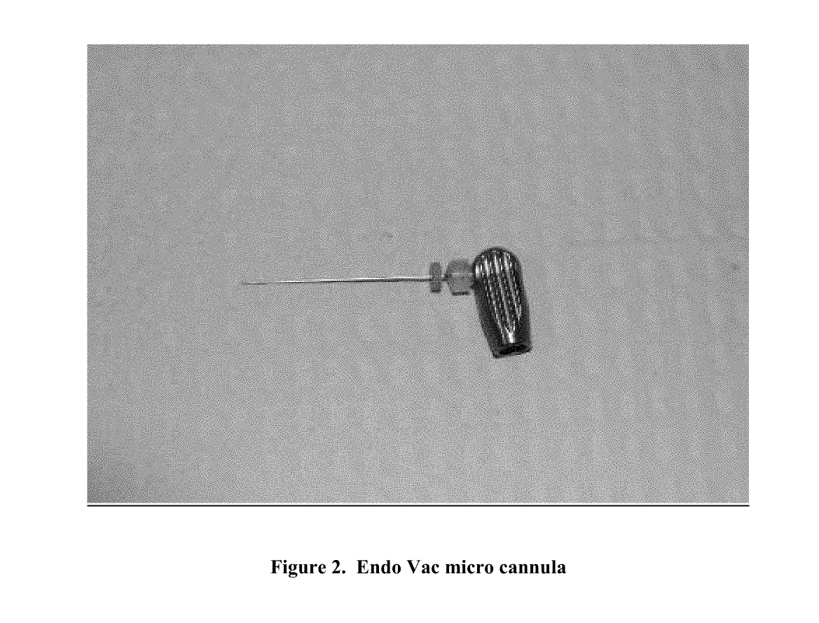

Materials and Methods of the Study: Fifty extracted teeth were retrieved from a local oral surgeon. The teeth included mature teeth, immature teeth, anteriors, premolars and molars. Based on the teeth received, they were divided into three groups based on the integrity of the apical morphology. The teeth were left in a jar of water to keep them hydrated. One day before the root canal preparation the teeth were mounted in a silicone ice cube tray, utilizing a mix of fifty percent of Plaster of Paris and fifty percent clear acrylic resin powder. As illustrated in FIG. 1, the teeth were sealed apically with a hollow plastic bead attached to the apex with sticky wax to keep it in position. The end of the bead was sealed with wax to maintain an airspace in the bead. Referring to FIG. 2, the idea was to keep the plaster/acrylic mix from coming into contact with the apical portion of the tooth, thereby preventing the clogging of the micro cannula. The teeth were left over night in humid conditions to prevent the teeth from developing cracks. The plaster mix remains damp for a few hours after the teeth were mounted and this further prevented the teeth from drying out.

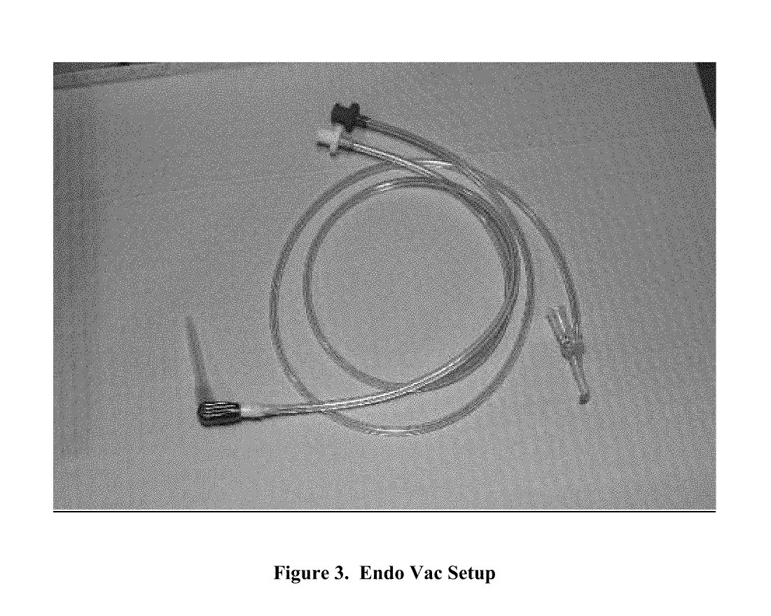

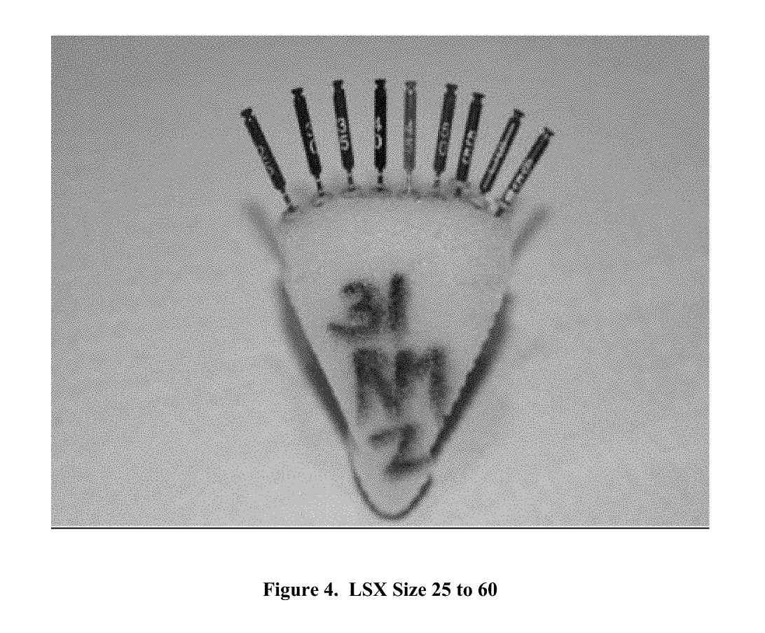

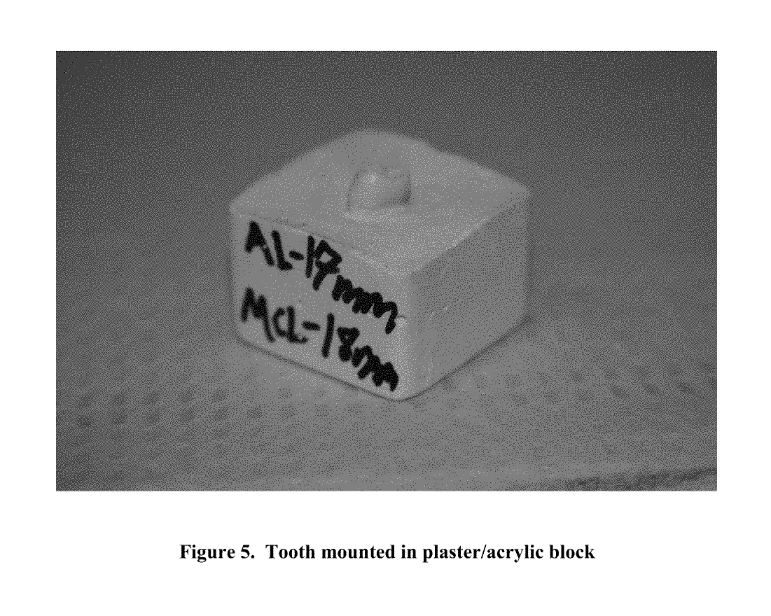

The teeth were accessed using 330 pear-shaped burrs, to the root system. The access was done utilizing a surgical operating microscope. Working length was determined by introducing a file to resistance and x rays were taken utilizing a wax x-ray jig. Working length was 0.5 mm from the radiographic apex (2, 3). The root canal system was instrumented using TF adaptive files to length followed by light speed instrumentation to a size of 40 to 50 (8) as the final LSX size depending on the tooth (FIG. 5). Patency was maintained and positive pressure was utilized up until final irrigation. Final irrigation was accomplished with a negative pressure irrigating device (FIGS. 3 and 4).

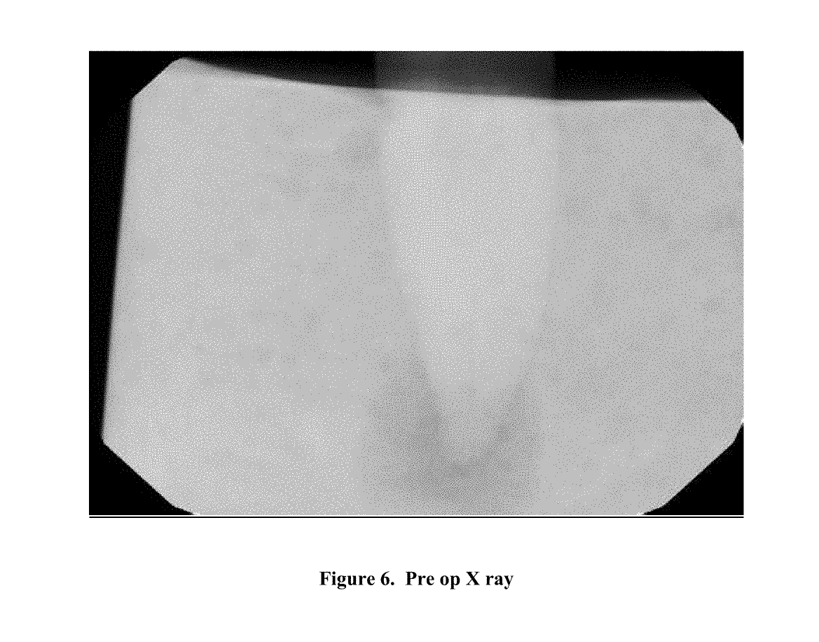

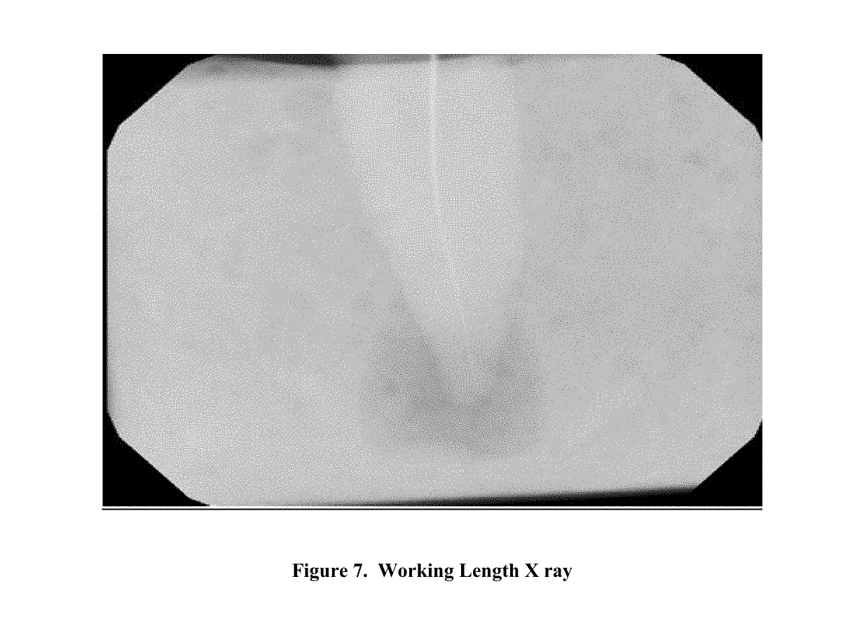

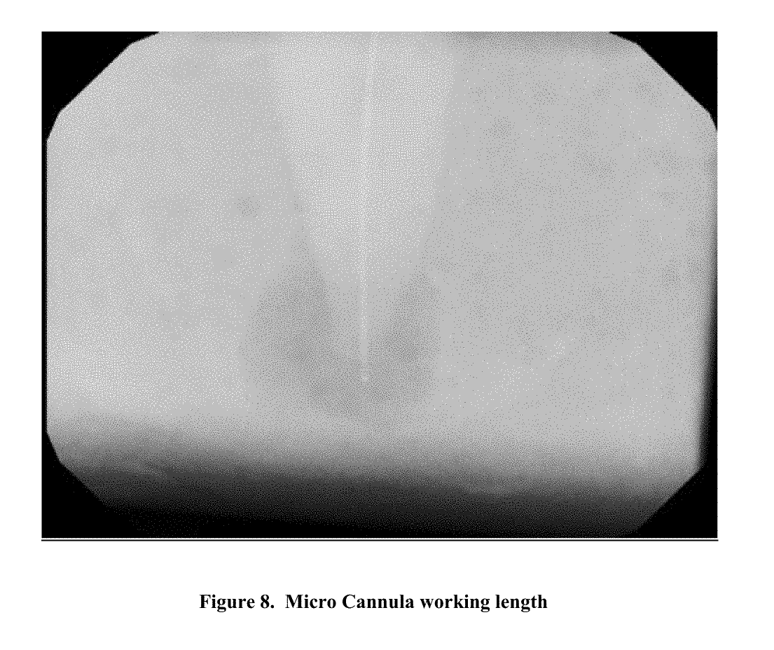

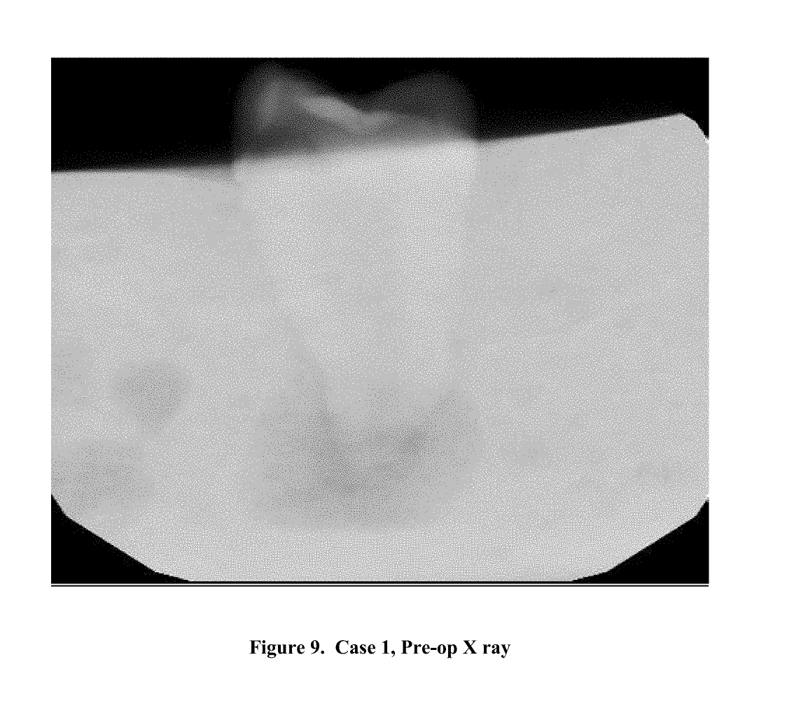

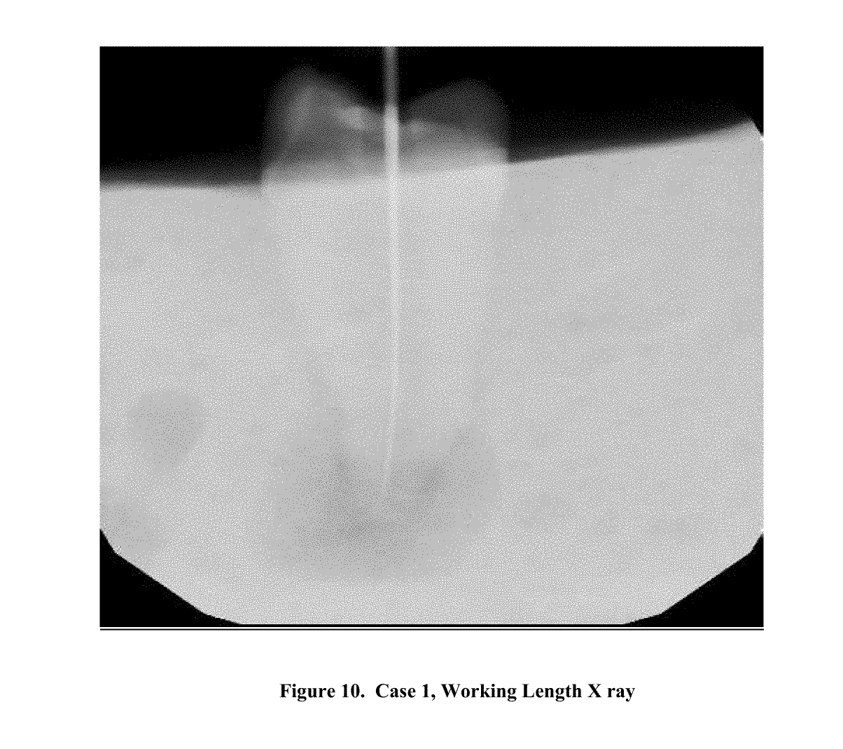

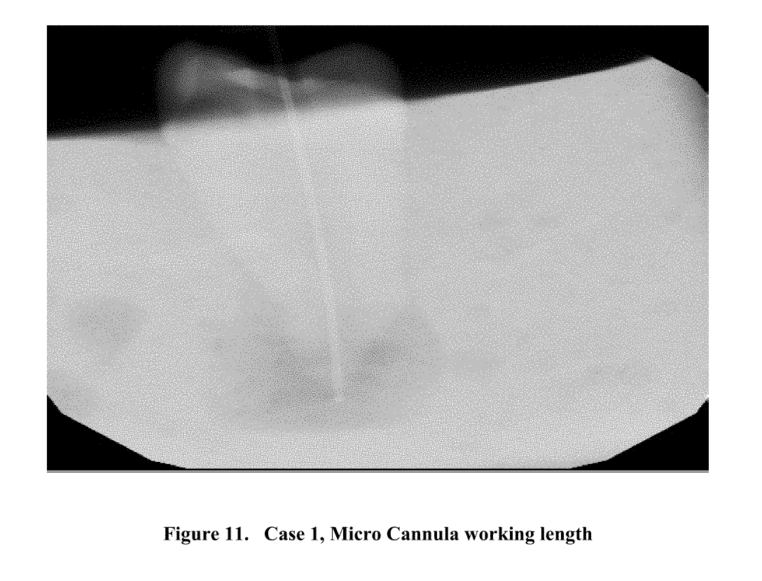

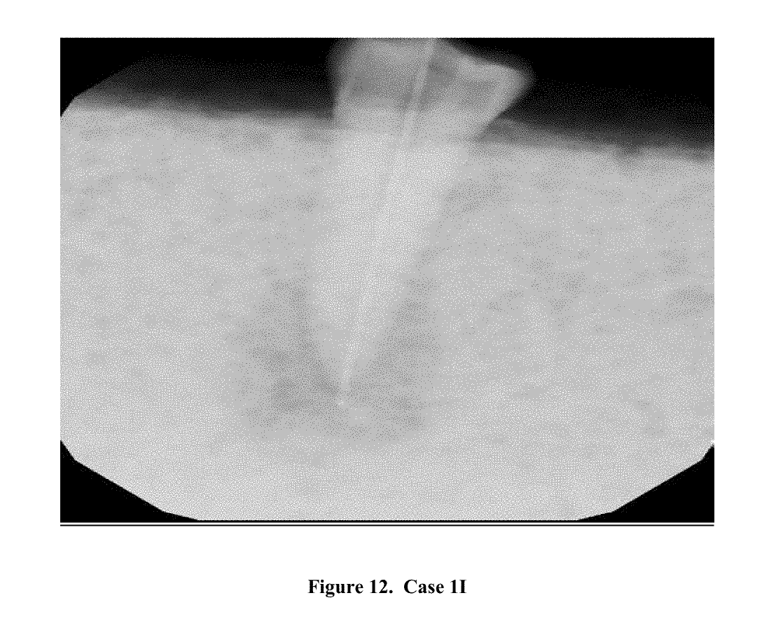

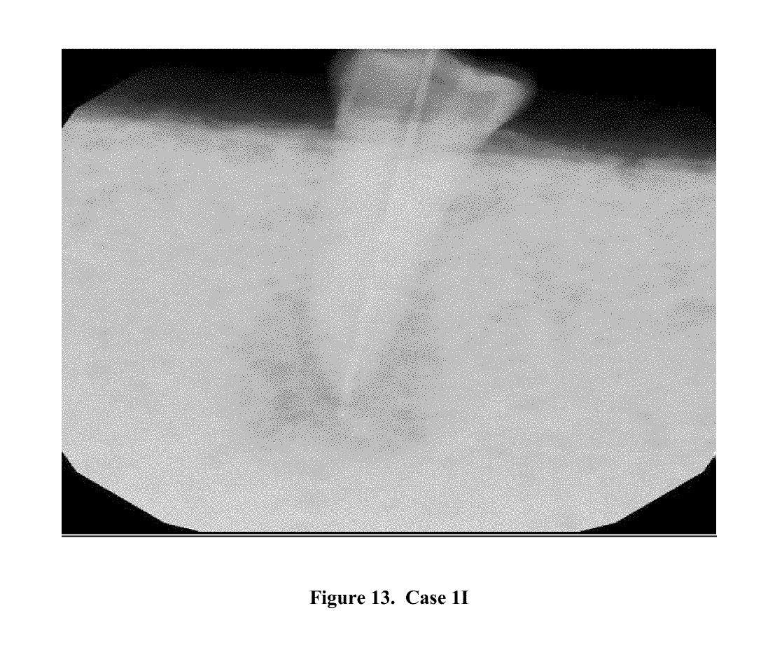

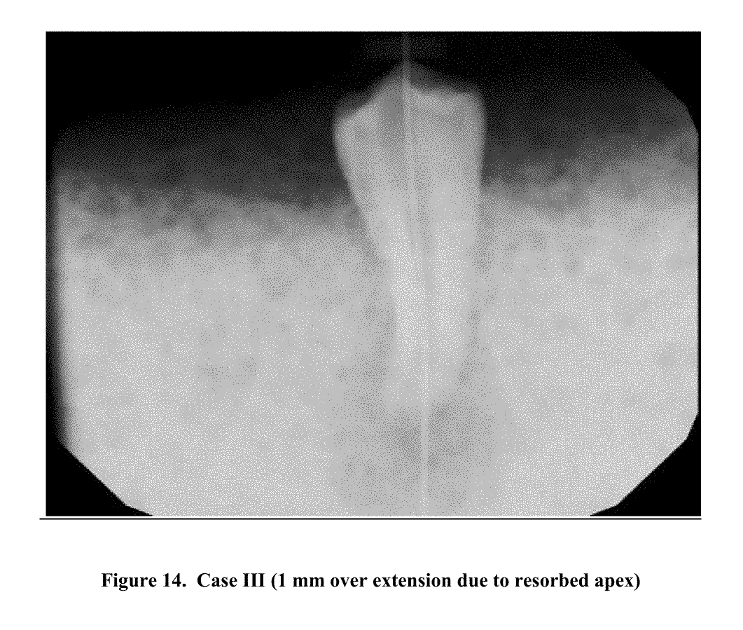

Referring to the x-ray illustrations of FIGS. 6-14, as the micro cannula approached the apical constricture, the trapped air in the plastic bead was released and this was noted as a change in flow of the irrigating solution through the clear plastic tubes. The rubber stop was set to the reference point, the micro cannula was detached from the irrigating system and left in the tooth, which was then set in the x ray jig and x rays were taken. The length was noted with the micro cannula. The lengths were then compared to the initial working length measurements to determine if there was a fixed pattern that developed as the cases were done.

Positive Control—Fluid slowed down and bubbles were released as the micro cannula approached the root apex.

Negative Control—No fluid flow was seen through the tubes without the use of the micro cannula.

Results: (a) Twenty three (23) teeth WLEV (46%) were 0.5 mm beyond the apex. These teeth had well-formed apices. (b) Twenty three (23) teeth WLEV (46%) were 1 mm beyond the apex. These teeth had resorbed apices. (c) Four (4) teeth (8%) were grossly over extended. These included blunder buss apices and cracked teeth.

(0.5 mm-1 mm)

| Tooth | Actual Working | Working Length with |
|---|---|---|
| Number | Length AWL (mm) | Endo Vac (WLEV) (mm) |
| #1 | 25.0 | 26.0 |
| #2 | 21.5 | 22.5 |
| #3 | 24.5 | 25.5 |
| #4 | 23 | 23 |
| #5 | 24 | 24 |
| #6 | 19 | 20 |
| #7 | 21.5 | 22.5 |
| #8 | 19 | 20.5 |
| #9 | 17.5 | 18.5 |
| #10 | 20 | 21 |
| #11 | 21 | 22 |
| #12 | 24 | 25 |
| #13 | 20 | 21 |
| #14 | 21 | 22 |
| #15 | 20 | 21 |
| #16 | 21 | 22 |
| #17 | 25 | 26 |
| #18 | 24.5 | 25 |
| #19 | 22.5 | 23 |
| #20 | 23.5 | 24 |
| #21 | 21 | 21.5 |
| #22 | 22.5 | 23 |
| #23 | 21 | 21.5 |
| #24 | 22.5 | 23 |
| #25 | 25 | 26 |
| #26 | 24 | 24.5 |
| #27 | 23 | 23.5 |
| #28 | 18 | 19 |
| #29 | 20.5 | 21.5 |
| #30 | 20.5 | 21 |
| #31 | 23 | 23.5 |
| #32 | 25 | 26 |
| #33 | 27 | 27.5 |
| #34 | 23 | 23.5 |
| #35 | 24 | 24.5 |
| #36 | 25 | 25.5 |
| #37 | 26 | 26.5 |
| #38 | 27 | 27.5 |
| #39 | 24 | 24.5 |
| #40 | 21 | 22 |
| #41 | 23 | 23.5 |
| #42 | 24 | 24.5 |
| #43 | 25 | 26 |
| #44 | 24.5 | 25 |
| #45 | 25.5 | 26.5 |
| #46 | 23 | 23.5 |

Outliers (+1.5 mm)

| Tooth | Actual Working | Working Length with |
|---|---|---|
| Number | Length AWL (mm) | Endo Vac (WLEV) (mm) |
| #1 | 19 | 25 |
| #2 | 21 | 25 |
| #3 | 20 | 23 |
| #4 | 23 | 26 |

Discussion: To the knowledge of the inventors, this technique has not been performed before, as such there were no guidelines to follow for developing an accurate study model. A significant challenge encountered in the study was in obtaining teeth that had intact apical anatomy, i.e., no apical resorption, no blunder buss canal and no fractured teeth. The teeth that had calcified canals, upon instrumentation developed cracks. The teeth with open apices were inconsistent with this technique. This was attributed to the fixed diameter of the micro cannula. The teeth that had consistent results had perfectly rounded apices with no apical resorption and a visible canal system. These teeth had stable apical constrictures which acted as a seal for the micro cannula. When the micro cannula exited the constricture, negative pressure was lost and the bubbles were released from the bead. Teeth that had resorbed apices resulted in loss of apical constricture and hence the entire micro cannula tip (0.7 mm) had to exit the root end. The teeth that had fractures and open apices could not provide a seal apically and hence the significant difference in length (up to 5 mm in one case).

During the length determination with negative pressure, observing the change in flow pattern (escape of air bubbles) needed the use of microscope. When the rubber stop was placed in contact with the reference point, the micro cannula sometimes moved, hence the need for steady hands.

This technique eliminates the need to reintroduce a probe into the root canal system for final length with the apex locator. Once the length is confirmed the micro cannula is used to remove the excess irrigating solution prior to drying with paper points. This eliminates any further debris creation with the use of a probe. This technique is highly effective in areas of the mouth that are hard to reach or teeth that are extremely long anatomically, i.e., (31 mm) and above. Some clinical cases have been presented to provide a sense of what can be accomplished using this technique. The use of light speed keeps the preparation of the canal conservative and eliminates apical restriction to the movement of the micro cannula. Without light speed introduced into the preparation the micro cannula was seen to bend prematurely or to come apart during use. It also clogged up frequently making it hard to have consistent flow. These observations were made in an In Vivo setting.

Negative pressure only accounts for vertical fluid movements but no lateral circulation between the canals.

The inventors concluded that the determination of the working length is more accurate when more than one technique is used, i.e., apex locators and working length x rays. This is an additional technique that if refined can eliminate the need for x ray technique. It also has an added advantage of eliminating the debris in the zone between the apical constricture and the radiographic apex, a distance of which varies from 0.5 mm up to 2 mm from the apex. In the right hands, using a strict instrumentation technique as mentioned above this working length confirmation can be used as an adjunct to length confirmation prior to obturation. In intact apical morphology subtracting a 0.5 mm from the length after the fluid stops moving gives us the final working length. Care should be taken in situations with long standing periapical pathology as this could lead to inconsistent length measurements. This technique should not be applied in teeth with open apices.

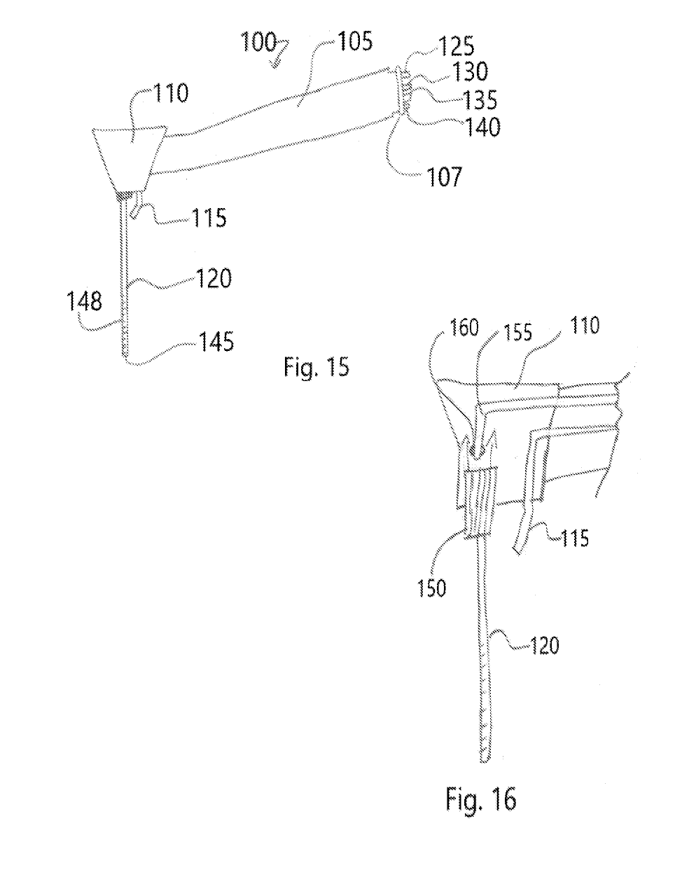

Referring to FIG. 15, the inventors have determined that one solution to the problem of irrigating and disinfecting during an endodontic procedure is provided by use of a handpiece 100 that is configured to provide both positive pressure irrigation and negative pressure irrigation. The handpiece 100 includes a handgrip 105, a cable mounting end 107, and a head 110. The head 110 includes a positive pressure outlet irrigation tube 115 and a negative pressure inlet irrigation tube 120. The mounting end 107 include connectors for mating with a cable (not shown). The connectors on the mounting end 107 include an optional fiber optic connector 125, a negative pressure irrigation connector 130, a positive pressure connector 135 and an optional high pressure air inlet connector 140.

The positive pressure connector 135 and the positive pressure outlet irrigation tube 115 are connected with a line to permit the irrigation fluid to flow through a cable to the connector 135 and out through the tube 115. The negative pressure connector 130 and the negative pressure irrigation tube 120 are connected with a line to permit the irrigation fluid to flow through the negative pressure inlet irrigation tube 120 to the connector 130.

The optional fiber optic connector 125 is used to provide a light source to the handpiece 100. The light source may be on the head 110 and used to illuminate the region in which the irrigation tube 120 is used. The head 110 can include a fiber optic cable or the like that passes from the connector 125 to a light source on the head.

The optional high pressure air inlet connector 140 can be used, if desired, to rotate the head and irrigation tube 120. During use, rotating the irrigation tube 120 may improve negative pressure irrigation of the procedure area.

The irrigation tube 120 also may include markings 146 along its length to indicate length from the distal tip opening 145 of the tube. The endodontist can use the markings to determine the depth within the tooth in a procedure.

The irrigation tube 120 can be permanently or removably attached to the head 110. For example, referring to FIG. 16, the irrigation tube can include the distal tip opening 145 at one end and a mounting portion 150 at the other end. The tube includes a channel along its length through which a negative pressure pulls in irrigation fluid. In one embodiment, the mounting portion 150 is forced into the head 110 and over the negative pressure line 155. The distal end of the negative pressure line 155 includes a bulbous end 160. Forcing the mounting portion 150 over the bulbous end 160 forms a seal between the channel in the line 155 and the channel in the tube 120. However, the irrigation tube 120 can be removed after use and disposed. The remainder of the head 110 and handgrip 105 can be autoclaved for example to permit multiple use. Alternatively, the head 110 and handgrip 105 can be disposable.

The tube 120 will be approximately 0.5 cm to 2 cm in length and have an outer diameter of approximately 0.05 mm to 0.1 mm in outer diameter. The tube can be made from any one of a variety of materials, including a stainless steel, aluminum, a nickel titanium alloy, or a polymer. In a preferred embodiment, the material used permits the tube to be flexible.

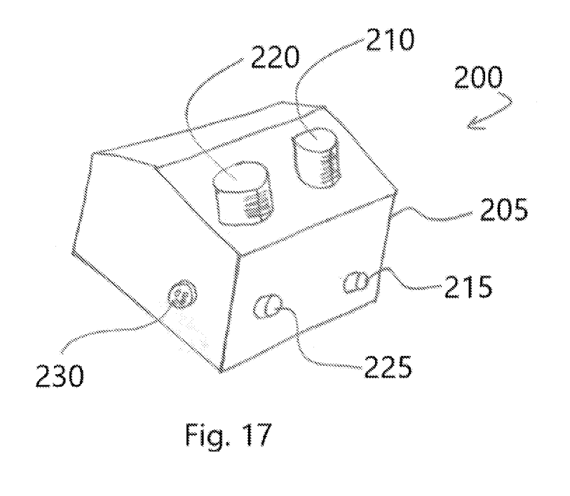

Referring to FIG. 17, the handpiece 100 is used in conjunction with a console 200 by connecting the handpiece to the console with a cable that includes channels or lines for the positive and negative pressure lines, the optional fiber optic cable and the optional high pressure air line. The console 200 includes a mounting end 230 to which the cable can be attached. The console also includes two pumps (not shown) mounted in the enclosure 205. A first pump creates a negative pressure condition that pulls fluid into a first chamber 210. The operation of the first, negative pressure pump is controlled by the controller 215 so that more or less negative pressure can be created. A second pump creates a positive pressure condition that pulls fluid out of a second chamber 220. For example, the second chamber 220 can include sodium hypochlorite. The operation of the second, positive pressure pump is controlled by the controller 225 so that more or less positive pressure can be created.

As should be evident, when a first end of the cable is connected to the console 200 at mounting end 230 and the second end of the cable is connected to the handpiece at mounting end 107, negative pressure created by the negative pressure pump in its associated line will create negative pressure at the opening 145 in the irrigation tube 120, which will suction fluid into the chamber 210. Similarly, the positive pressure pump can be used to pump irrigation fluid out of the second chamber 220, through the mounting end 230, through the cable, through the mounting end 107 and through the irrigation line 115 into the procedure field.

The configuration of the chambers 210, 220 are designed to permit fluid levels to be measured. The inventors recognize the importance of ensuring that sufficient amounts of irrigating fluid are used to clean and disinfect the root, especially the apical third of the root. However, the inventors stress the importance of ensuring that whatever amount of irrigating fluid is used to clean and disinfect the root is removed from the root. To accomplish this the chambers are marked to show volumes or other measures of fluid usage and recovery. For example, if ten milliliters are used to clean and disinfect the root, approximately ten milliliters of fluid must be removed. If a hypochlorite solution is used to clean and disinfect the root, that fluid should be removed to prevent leaving fluid in the root area because such fluids are likely to cause discomfort, pain and adverse effects.

As explained above the inventors found that based on the depth within the root the endodontist will either irrigate out fluid or air bubbles. Thus, the system permits the endodontist to determine the depth of the tube 120 within the root canal. With the system being used in a procedure, fluid is pumped into the system through tube 115 and suctioned out through tube 120. As fluid builds up in the canal while the tube 120 is advanced into the canal, the tube 120 will be suctioned into the tube. Upon entering the apical third of the root where typically an apical airlock prevents complete irrigation and suctioning of the apical third, the tube 120 is expected to break the airlock and permit irrigation and disinfection of the entire canal and root.

As the tube 120 gets close to the tissue at the apex of the root, the irrigation will return bubbles rather than fluid. This permits the endodontist to avoid clogging the tube 120 with tissue and spend unnecessary time cleaning the tubing and subsequent delay of the procedure. This technique was described in the study discussed herein.

The system also permits the endodontist to irrigate in an endodontic procedure without assistance from a second person. Typically, irrigation in these procedures is a two-person requirement with one person holding the irrigation tubing and providing irrigation fluid while the second person uses negative pressure to suction out the fluid. Using the handpiece described herein, the endodontist, dentist or even dental student can irrigate, cleanse and disinfect the root canal while monitoring the irrigation to know how close the opening 145 of the tube 120 is to the root apex.

As an optional feature of the handpiece 100 and console 200, the system can include sensors to monitor the fluid returned through the negative pressure tube 120. For example, the sensor can detect one or more of air bubbles, rate of fluid flow or change in rate of fluid flow, or a change in pressure in the line, etc. that demonstrates that the fluid suctioned within the tube contains a sufficient quantity of air bubbles. Upon detecting air bubbles or a change in rate of fluid flow (e.g., reduction in rate) the console can emit an audio of visual signal. The sensor can be in the handpiece, between the handpiece and the cable, or in the console. Upon hearing or seeing the audio or visual signal, the endodontist can pull back on the handpiece or hold it in a steady position.

The endodontist also can visually check the chambers 210 and 220 to ensure that the fluid used in the procedure has been captured and removed from the patient's root canal. For example, if not as much fluid has been recovered as was used to irrigate, the endodontist would insert the tube 120 into the root canal and apply negative pressure to remove the fluid.

### REFERENCES USED HEREIN

1. Apical Limit of Root Canal Instrumentation and Obturation part 1. Literature review: International Endodontic Journal (1998) 31.384-393.
2. Apical Limit of Root Canal Instrumentation and Obturation part II. A histological study. D. Ricucci and K. Langeland: International Endodontic Journal (1998) 31.394-409.
3. Shaping Ability of Light Speed Rotary Nickel Titanium Instruments in Simulated Root Canals Part 1: S. A. Thompson, BDS, MPhil, and P. M. H. Dummer, BDS, MScD, PhD: Journal of Endodontics Vol. 23, No. 11, November 1997.
4. Shaping Ability of Light Speed Rotary Nickel Titanium Instruments in Simulated Root Canals Part II: S. A. Thompson, BDS, MPhil, and P. M. H. Dummer, BDS, MScD, PhD: Journal of Endodontics Vol. 23, No. 12, November 1997.
5. Incidence of Instrument Separation using Light Speed Rotary Instruments: Kenneth I. Knowles, DDS, MS, Nathan B. Hammond, BA, Stephen G. Biggs, DDS, and Jose L. Ibarrola, DDS, MS, JOE, Volume 32, Number 1, January 2006.
6. Comparison of Apical Transportation between two Rotary File Systems and Two Hybrid Rotary Instrumentation Sequences: Frank C. Setzer, DDS, MS, PhD, Tae-Kyung Kwon, DDS, MSD, and Bekir Karabucak, DMD, MS, JOE—Volume 36, Number 7, July 2010.
7. Efficacy of Different Irrigation and Activation systems on the Penetration of Sodium Hypochlorite into Simulated Lateral Canals and up to Working Length: An In Vitro Study. Cesar de Gregorio, DDS, MS, Roberto Estevez, DDS, Rafael Cisneros, DDS, Avina Paranjpe, BDS, MS, PhD, and Nestor Cohenca, DDS, JOE—Volume 36, Number 7, July 2010.
8. Effect of Apical Preparation Size and Preparation Taper on Irrigant Volume Delivered by using Negative Pressure Irrigation System: Matthew Brunson, DDS, MSD, Carlos Heilborn, DDS, D. James Johnson, DDS, MS, and Nestor Cohenca, DDS, JOE—Volume 36, Number 4, April 2010.
9. Comparison of Apical Extrusion of NaOCL using the EndoVac or Needle Irrigation of Root Canals: Ross Paton Mitchell, DMD, Sung-Eun Yang, DDS, PhD, and J. Craig Baumgartner, DDS, PhD, JOE—Volume 36, Number 2, February 2010.
10. Comparison of the Antimicrobial Efficacy of Irrigation Using the EndoVac to Endodontic Needle Delivery: Todd A. Miller, DDS, and J. Craig Baumgartner, DDS, PhD, JOE Volume 36, Number 3, March 2010.
11. Smear Layer Removal and Canal Cleanliness Using Different Irrigation Systems (EndoActivator, EndoVac, and Passive Ultrasonic Irrigation): Field Emission Scanning Electron Microscopic Evaluation in an In Vitro Study. Manuele Mancini, DDS, Loredana Cerroni, DDS, Lorenzo Iorio, DDS, Emiliano Armellin, DDS, Gabriele Conte, DDS, and Luigi Cianconi, MD, DDS, JOE—Volume 39, Number 11, November 2013.
12. Use of EndoVac System for Aspiration of Exudates from a Large Periapical Lesion: A Case Report: Ali Keles, PhD, and Hatice Alcin, DDS: JOE—Volume 41, Number 10, October 2015.
13. Periapical Pressures Developed by Nonbinding Irrigation Needles at Various Irrigation Delivery Rates. Sara Khan, DMD, Li-na Niu, DDS, MS, Ashraf A. Eid, BDS, MSc, Stephen W. Looney, PhD, Anthony Didato, DMD, Steven Roberts, DMD, David H. Pashley, DMD, PhD, and Franklin R Tay, BDSc (Hons), PhD: JOE—Volume 39, Number 4, April 2013.
14. Influence of an Apical Negative Pressure Irrigation System on Bacterial Elimination during Endodontic Therapy: A Prospective Randomized Clinical Study: Rekha Pawar, DDS, MDS, Abdullah Alpied, DDS, Kamran Safavi, DMD, Med, Jennifer Boyko, BS, and Blythe Kaufman, DMD, MDS: JOE—Volume 38, Number 9, September 2012.
15. In Vivo Efficacy of Three Different Endodontic Irrigation Systems for Irrigant Delivery to Working Length of Mesial Canals of Mandibular Molars. Hugo Roberto Munoz, DDS, MA, and Karala Camacho-Cuadra, DDS: JOE—Volume 38, Number 4, April 2012.
16. Comparison of the EndoVac System to Needle Irrigation of Root Canals: Benjamin A. Nielsen, DMD, and J. Craig Baumgartner, DDS, PhD: JOE-Volume 33, Number 5, May 2007.

What is claimed is:

1. A handpiece for simultaneously irrigating and suctioning during an endodontic procedure, the handpiece comprising a handle portion comprising a first fluid line and a second fluid line passing into a head portion comprising an outlet for the first fluid line and an inlet for the second fluid line.

2. The handpiece of claim 1, wherein the first fluid line and the outlet for the first fluid line form fluid tight a connection and the second fluid line and the inlet for the second fluid line form a fluid tight connection.

3. The handpiece of claim 1, further comprising a third line passing between the handle portion and the head portion, wherein the third line comprises a fiber optic cable and the head portion includes a light source.

4. The handpiece of claim 1, further comprising a fourth line passing between the handle portion and the head portion, wherein the fourth line provides high pressure air to turn the head.

5. The handpiece of claim 1, further comprising an irrigation tube mountable to the inlet for the second fluid line at the head portion.

6. The handpiece of claim 5, wherein the irrigation tube has a channel passing between a first open end and a second open end.

7. The handpiece of claim 5, wherein the irrigation tube is made of stainless steel, a nickel titanium alloy, aluminum, or a polymer.

8. The handpiece of claim 1, further comprising a console having a first pump, a second pump, a first chamber, and a second chamber, wherein the first pump creates a negative pressure to suction fluid into the first chamber, the second pump creates a positive pressure to pump fluid from the second chamber.

9. The handpiece of claim 8, wherein the console further comprises a mounting end for mounting a cable from the console to the handpiece to provide a fluid connection between the first fluid line in the handpiece and the second pump and provide a fluid connection between the second fluid line in the handpiece and the first pump, whereby operating the console with the handpiece provides fluid through the second fluid line in the handpiece and suction fluid through the first fluid line in the handpiece.

10. A method of irrigating in a dental procedure, the method comprising:
providing a handpiece for simultaneously irrigating and suctioning during the dental procedure, the handpiece comprising a handle portion comprising a first fluid line and a second fluid line passing into a head portion comprising an outlet for the first fluid line and an inlet for the second fluid line;
providing a console having a first pump, a second pump, a first chamber, and a second chamber, wherein the first pump creates a negative pressure to suction fluid into the first chamber, the second pump creates a positive pressure to pump fluid from the second chamber;
forming a first fluid connection between the handpiece and the console, the first fluid connection being between the first fluid line in the handpiece and the second pump, whereby operating the console with the handpiece suctions fluid through the first fluid line in the handpiece; and
forming a second fluid connection between the handpiece and the console, the second fluid connection being between the second fluid line in the handpiece and the first pump, whereby operating the console with the handpiece provides fluid through the second fluid line in the handpiece.

11. The method of claim 10, wherein the handpiece further comprises an irrigation tube mounted to the inlet for the second fluid line in the head portion, the irrigation tube having a first opening, a second opening and a channel between the first opening and the second opening.

12. The method of claim 11, further comprising inserting the irrigation tube into a cavity while simultaneously irrigating and suctioning through the handpiece.

13. The method of claim 11, wherein the cavity is a root canal formed in an endodontic procedure.

14. The method of claim 13, wherein one or more of the handpiece and the console further comprises a sensor for detecting air bubbles or fluid flow and detecting air bubbles or a reduction in fluid flow causes emission of an audible or visual signal.

15. The method of claim 12, further comprising advancing the irrigation tube into the cavity until air bubbles are drawn into the irrigation tube.

16. The method of claim 12, further comprising advancing the irrigation tube into the apical third of the root until reaching the apical vapor lock.

17. The method of claim 10, wherein operation of the handpiece is by a single operator.

18. The method of claim 10, wherein the dental procedure is a root canal procedure.

19. The method of claim 10, further comprising a third line passing between the handle portion and the head portion, wherein the third line comprises a fiber optic cable and the head portion includes a light source.

20. The method of claim 10, further comprising a fourth line passing between the handle portion and the head portion, wherein the fourth line provides high pressure air to turn the head.
